(19) United States
(12) Patent Application Publication
(10) Pub. No.: US 2002/0067133 A1
(43) Pub. Date: Jun. 6, 2002

(54) Method for lighting an inductively coupled plasma at low pressure

(76) Inventors: Jeffrey J. Brown, Fishkill, NY (US); John H. Keller, Newburgh, NY (US); Waldemar Walter Kocon, Wappingers Falls, NY (US)

Correspondence Address: Jay H. Anderson, Intellectual Property Law, IBM Corporation, 2070 Route 52, Hopewell Junction, NY, 12533-6531, US

(21) Appl. No.: 09/730,672

(22) Filed: Dec. 6, 2000

(51) Int. Cl. H01J 7/24

(52) U.S. Cl. 315/111.51

(57) ABSTRACT

A method is described for lighting an inductive plasma in a plasma processing tool having a matching network, at pressures of about 20 mTorr and below. A matching condition for a capacitive plasma is determined, which then is used to define a match preset condition. When a plasma is started with the matching network in that preset condition, a capacitive plasma ignites and is maintained with a minimum of power. Excess power (power greater than that required to maintain the capacitive plasma) transfers the plasma to the inductive mode. The matching condition for the capacitive plasma may be determined by lighting a plasma, setting a power delivered thereto at not more than about 20 watts, and allowing the matching network to tune to the plasma. A capacitive plasma may be easily started at this preset condition. Current produced in the coil due to the excess power then causes the inductive plasma to light. The matching network changes from the preset matching condition to a matching condition under which the matching network is tuned to the inductive plasma.

### FIELD OF THE INVENTION

This invention relates to semiconductor processing, and more particularly to an improvement in the use of plasma processing apparatus in the manufacture of semiconductor devices.

### BACKGROUND OF THE INVENTION

Plasma processing, including etching and deposition, is a well-known technique in the semiconductor industry. In a typical plasma processing apparatus, radio frequency (RF) power is coupled to a low-pressure gas mixture to produce a plasma with the desired etch or deposition properties.

A typical plasma processing tool is shown schematically in FIG. 1. An RF source 20 and matching network 22 drive an RF induction coil 16. The matching network compensates for the impedance, real and imaginary, of the plasma. The induction coil is grounded through an impedance 24. The plasma 12 is produced in chamber 14 which is separated from the coil by a dielectric window 18. Chamber 14 has a grounded wall 15. Gas feed lines and a vacuum system (not shown) establish the gas chemistry and maintain the pressure in chamber 14. A workpiece 41, typically a semiconductor wafer, is held onto a chuck 42 by a mechanical or electrostatic clamp. Chuck 42 is also an electrode driven by RF bias supply 40 and matching network 44.

The net power delivered to the RF coil 16 (also called the effective forward power) is given by the forward power (from the RF generator) minus the reflected power. The net power is partially delivered to the plasma and partially dissipated in the resistance of the coil. A plasma may be characterized by its efficiency; an inefficient plasma has a resistance about 50% to 100% of the coil resistance, while an efficient plasma has a resistance 3 to 4 times that of the coil.

As is understood by those skilled in the art, the RF power may be coupled to the plasma either capacitively or inductively. An increase in delivered power increases the electron density in the plasma; in the case of a capacitive plasma, the efficiency (the effectiveness of the RF power in producing the plasma) is inversely proportional to the density. On the other hand, the efficiency of an inductive plasma increases with increasing density, for densities in the range presently used in etching and deposition.

Inductive plasmas are thus very efficient at high plasma densities. Indeed, the maximum efficiency of inductive plasmas is generally obtained at plasma densities exceeding those of most high-density etching and deposition tools used today. However, inductive plasmas have a number of properties which make them difficult to light (that is, start or ignite the plasma):

(1) The efficiency of inductive plasmas decreases with the plasma density and pressure. They therefore have very low efficiency at low densities and the lower pressures where it is desired that they operate. Stated another way, for a fixed plasma density the inductive resistance of the plasma is proportional to the gas density, which in turn is generally related to the pressure by the ideal gas law. Ignition of an inductive plasma requires that the current in the RF coil exceed a threshold current which is inversely proportional to the resistance. Inductive plasmas are therefore more difficult to ignite at low pressure than capacitive plasmas.

(2) The current in the inductive coil or antenna which drives the inductive plasma must exceed a large threshold current in order to sustain the plasma. (For this reason many systems in the 1970s which were thought to be inductive plasmas actually were not; those systems operated at much lower densities.)

(3) The tuning wells for inductive plasmas are asymmetric; that is, wider as the tuning is approached from lower density (where there is a larger effective inductance in the coil and matching network) and narrow and multi-valued on the other side. In some systems an attempt to tune the generator and matching network for minimum reflected power results instead in the tuning changing to another value where there is high reflected power.

When inductive plasmas were first used in semiconductor processing, it was thought that the optimum matching network settings for starting the plasma were those settings for which the system was matched for the case of no plasma (that is, simply resonating with the resistance of the coil or antenna). This hypothesis has since been found by experiment to be incorrect. Settings close to the matched setting for a high density inductive plasma are preferable, but still do not permit the inductive plasma to be easily lit.

Manufacturers of plasma processing tools (e.g. Lam Research Corp. and Applied Materials Corp.) recommend either (1) presetting the matching network slightly offset from the last setting where the inductive plasma was on, or (2) increasing the pressure in order to light the plasma. Neither procedure is satisfactory for reliably starting the plasma and obtaining a consistent plasma density (and hence a consistent amount of etching or deposition) at the beginning of the process.

Other workers have used the procedure of first applying the RF bias to the wafer before applying RF power to the antenna, in an attempt to light the inductive plasma using a glow produced by the RF bias. However, the matched conditions for the RF bias with and without the inductive plasma are substantially different. Furthermore, this procedure can cause damage to the devices and films on the wafer.

There remains a need for a reliable procedure for lighting an inductive plasma at low chamber pressure.

### SUMMARY OF THE INVENTION

The present invention addresses the above-described need by providing a method for lighting an inductive plasma in a plasma processing tool at low pressures (about 20 mTorr and below). In accordance with the present invention, this is done by determining a matching condition for a capacitive plasma, which then is used to define a match preset condition. When a plasma is started with the matching network in that preset condition, a capacitive plasma ignites and is maintained with a minimum of power. Excess power (power greater than that required to maintain the capacitive plasma) transfers the plasma to the inductive mode. This method does not require any changes to the hardware of the processing tool.

The matching condition for the capacitive plasma may be determined by lighting a plasma, setting a power delivered thereto at not more than about 20 watts, and allowing the matching network to tune to the plasma. This matching condition may then be recorded and used as the preset condition for the matching network. A capacitive plasma may be easily started at this preset condition. Current produced in the coil due to the excess power then causes the inductive plasma to light. The matching network changes from the preset matching condition to a matching condition under which the matching network is tuned to the inductive plasma.

### BRIEF DESCRIPTION OF THE DRAWINGS

FIG. 1 is a schematic illustration of a plasma processing tool in which the present invention may be advantageously practiced.

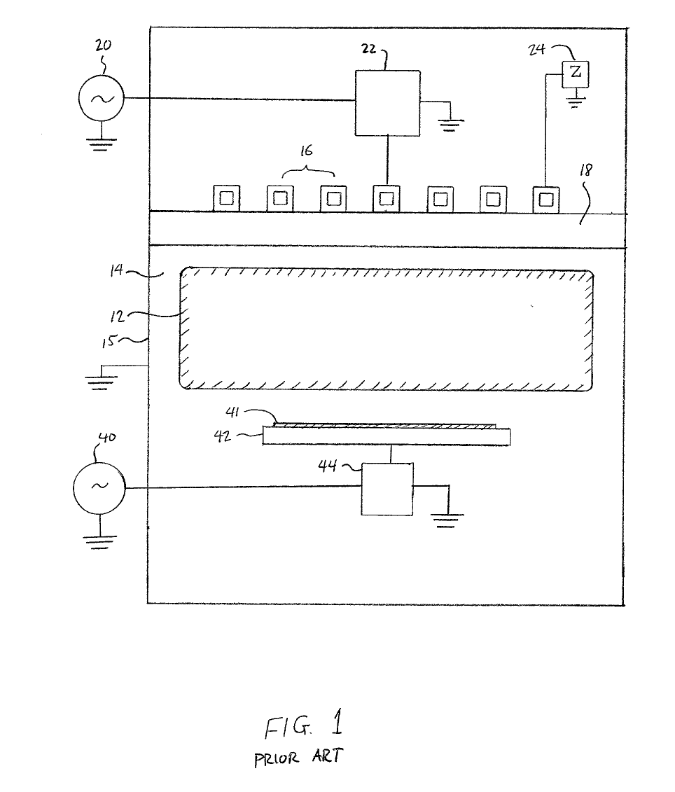

FIG. 2 is a diagram of an equivalent circuit for the RF coil and a plasma in a tool such as shown in FIG. 1.

FIG. 3 shows steps in a method for determining preset conditions for the RF generator and matching network, in accordance with the present invention.

FIG. 4 shows steps in a method for lighting an inductive plasma in accordance with the present invention, using the preset conditions determined by the process of FIG. 3.

### DETAILED DESCRIPTION OF A PREFERRED EMBODIMENT

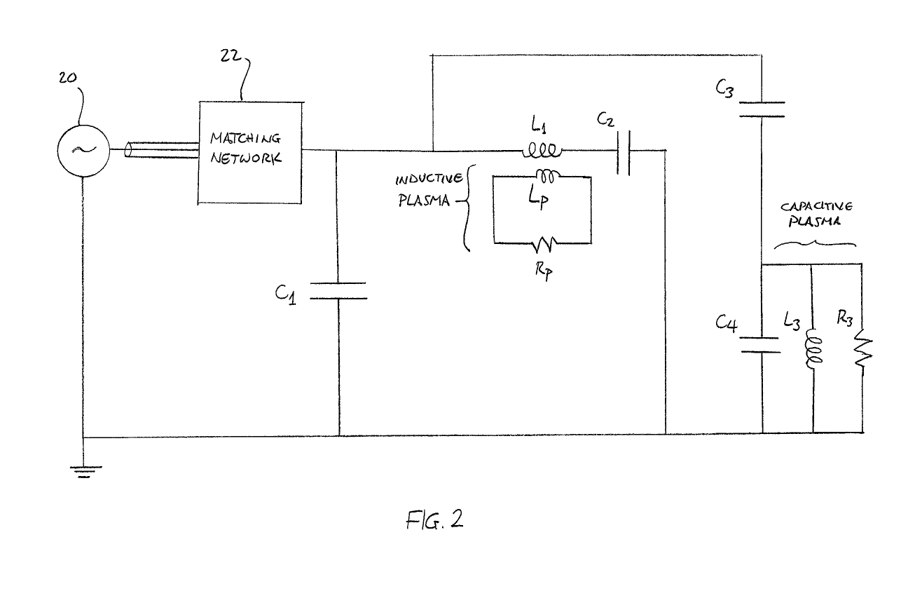

FIG. 2 shows a simplified version of the equivalent circuit of the RF coil 16 (also referred to as the RF antenna) and a plasma in a plasma processing tool. The matching network 22 is typically a “BT” or “II” type with two adjustable parameters (one of which, in particular, may be the frequency). The RF antenna is modeled as inductance L₁. The stray capacitance of the antenna with respect to ground is represented by C₁. The antenna coil and the inductive plasma act as a transformer, with the antenna coil as the primary and the inductive plasma (inductance Lₚ) as a one-turn secondary. The plasma resistance is represented by Rₚ. Both Lₚ and Rₚ are inversely proportional to the electron density of the plasma in the skin depth of the plasma near the antenna coil 16 and the dielectric window 18, between the antenna coil and the plasma. Inductance L₁ is led to ground through capacitance C₂. Capacitance C₃ represents the capacitance of the dielectric window 18 in series with the sheath capacitance of the plasma; sheath capacitance is a less-than-linearly decreasing function of the plasma density. Capacitance C₄ represents the capacitance of the plasma space from the window or plasma sheath to ground. Inductance L₃ represents the inductance in the plasma space between the plasma sheath and ground, and R₃ represents the effective resistance of the plasma with respect to power delivered to the plasma. Both L₃ and R₃ decrease roughly linearly with increasing electron density in the plasma. The actual circuit is complicated by inductive coupling between the antenna coil 16 and the ground wall 15, and by coupling between the ground wall 15 and the plasma 12.

As noted above, the efficiency of the inductive plasma decreases with decreasing plasma electron density, and approaches zero at low plasma densities. However, the capacitive plasma represented by C₄, L₃ and R₃ is efficient at very low densities. Accordingly, in any procedure for lighting a plasma, a capacitive plasma lights first and an inductive plasma lights afterward. A capacitive plasma may be maintained at a relatively low power (approximately in the range 1 to 20 watts). If effective forward power is supplied in excess of this range, large currents will be produced in the RF coil, which in turn cause an inductive plasma to be easily lit.

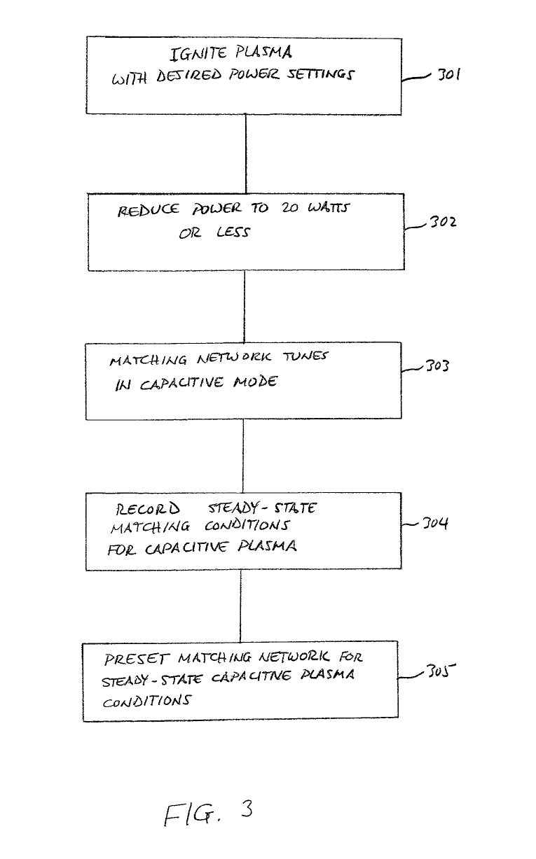

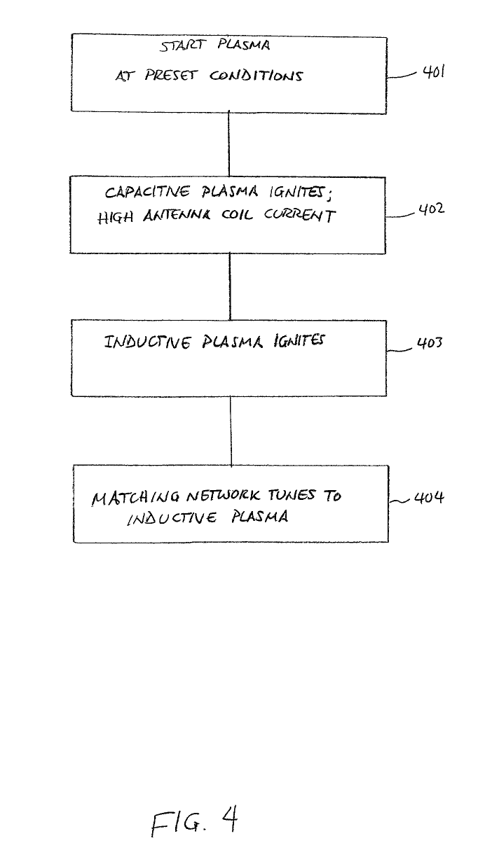

An inductive plasma may therefore be reliably lit by first determining steady-state matching conditions for a capacitive plasma, and then starting the plasma at those conditions with the desired effective forward power. The steps in these procedures are shown in FIGS. 3 and 4. FIG. 3 shows the procedure for obtaining the preset conditions. In step 301, a plasma is ignited at the desired power settings; the power is then reduced to about 20 watts or less (step 302). The RF power is then not sufficient to maintain an inductive plasma, so the matching network tunes so that it is matched to a capacitive plasma (step 303). When the capacitive plasma and matching network reach a steady state, the matching conditions recorded (step 304). These conditions are then used to preset the matching network (step 305).

FIG. 4 shows steps in the procedure for lighting the inductive plasma. In step 401, a plasma is efficiently started with the matching network at the preset conditions (that is, the steady-state capacitive plasma matching conditions found in step 303) and at the desired forward power. Accordingly, a capacitive plasma is efficiently ignited (step 402). Since the capacitive plasma can be maintained with a minimum of power, the remaining power is available to light the inductive plasma; accordingly, a large current appears in the RF antenna coil. An inductive plasma then ignites (step 403), and the matching network tunes to the matched condition for the inductive plasma (step 404). It has been found by experiment that the capacitive plasma ignites in less than 0.1 second, and the inductive plasma ignites less than 1 second thereafter. In addition, it has been found that this procedure is effective in lighting an inductive plasma at pressures as low as 0.3 mTorr, which is substantially below the general process pressure range of 0.5 to 70 mTorr.

It is also noteworthy that, as the plasma density increases, the matched condition for the inductive plasma is approached from the stable side of the tuning. The entire system (RF generator, matching network and plasma) thus remains stable during the lighting of both the capacitive and inductive plasma. Since the process for lighting the inductive plasma is stable, it is also easily repeatable.

While the invention has been described in terms of a specific embodiment, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

We claim:

1. A method for lighting an inductive plasma in a plasma processing apparatus having a matching network, the method comprising the steps of:
determining a matching condition under which the matching network is tuned to a capacitive plasma;
presetting the matching network at the matching condition determined in said determining step;
lighting a capacitive plasma in accordance with the preset matching condition and at a desired power exceeding a power required to maintain the capacitive plasma by an excess power; and
allowing an inductive plasma to light due to the excess power.

2. A method according to claim 1, wherein the plasma lit in said lighting step is a second plasma, and said determining step further comprises:
lighting a first plasma;
setting a power delivered to the first plasma at not more than about 20 watts;
allowing the matching network to tune to the first plasma as a capacitive plasma; and
recording the matching condition under which the matching network is tuned to the first plasma.

3. A method according to claim 1, wherein the plasma processing apparatus includes a coil for delivering power to the plasma, and a current produced in the coil due to the excess power causes the inductive plasma to light.

4. A method according to claim 1, wherein the matching condition determined in said determining step is a condition under which the capacitive plasma is maintained in a steady state.

5. A method according to claim 1, wherein the inductive plasma is lit in a chamber of the plasma processing apparatus having a gas pressure in the range of approximately 0.3 mTorr to 20 mTorr.

6. A method according to claim 1, wherein after said lighting step, the matching network changes from the preset matching condition to a matching condition under which the matching network is tuned to the inductive plasma.

7. A method according to claim 1, wherein the desired power is greater than about 20 watts.
